(19) United States
(12) Patent Application Publication
(10) Pub. No.: US 2016/0211103 A1
(43) Pub. Date: Jul. 21, 2016

(54) METHOD FOR OPERATING A CIRCUIT BREAKER AND CIRCUIT BREAKER

(71) Applicant: Siemens Aktiengesellschaft, Munchen (DE)

(72) Inventors: Pavel NAIMAN, Letohrad (CZ); Milos PETRACEK, Letohrad (CZ); Daniel VAVRA, Vyprachtice (CZ)

(21) Appl. No.: 14/968,951

(22) Filed: Dec. 15, 2015

(30) Foreign Application Priority Data
Jan. 20, 2015 (EP) 15151787.7

(51) Int. Cl. H01H 71/52

(52) U.S. Cl. CPC H01H 71/52; H01H 2205/002

(57) ABSTRACT

A method is disclosed for operating a circuit breaker. The circuit breaker includes an operating lever, a latching mechanism and an electrical contact system with a movable contact and a fixed contact. The operating lever is movable into an ON-position and an OFF-position. Further, the operating lever is mechanically connected to the electrical contact system via the latching mechanism such that when the operating lever is in its OFF-position, the contacts of the electrical contact system are opened and when the operating lever is in its ON-position, the contacts of the electrical contact system are closed. Further, such a circuit breaker is also disclosed.

### PRIORITY STATEMENT

The present application hereby claims priority under 35 U.S.C. §119 to European patent application number EP15151787.7 filed Jan. 20, 2015, the entire contents of which are hereby incorporated herein by reference.

### FIELD

At least one embodiment of the present invention is generally related to a method for operating a circuit breaker. More specifically, it is related to a method for operating a circuit breaker comprising an operating lever, a latching mechanism and an electrical contact system with a movable contact and a fixed contact, wherein the operating lever is movable into an ON-position and an OFF-position, wherein further the operating lever is mechanically connected to the electrical contact system via the latching mechanism such that when the operating lever is in its OFF-position the contacts of the electrical contact system are opened and that when the operating lever is in its ON-position the contacts of the electrical contact system are closed.

Further, at least one embodiment of the invention is generally related to a circuit breaker. More specifically, it is related to a circuit breaker comprising an operating lever, a latching mechanism and an electrical contact system with a movable contact and a fixed contact, wherein the operating lever is movable into an ON-position, an OFF-position and a RESET-Position, wherein further the operating lever is mechanically connected to the electrical contact system via the latching mechanism such that when the operating lever is in its OFF-position the contacts of the electrical contact system are opened, that when the operating lever is in its ON-position the contacts of the electrical contact system are closed and that when a movement of the operating lever in its RESET-position an activation of the latching mechanism is prepared by resetting the latching mechanism.

### BACKGROUND

In modern technical applications, circuit breakers are commonly used. Especially, circuit breakers can be used for circuit switching of high currents and powers respectively, for instance a circuit switching of currents as high as 70 kA and even higher. It is known to equip such circuit breakers with safety devices such as for instance an overload protection and/or a short-circuit protection and the respective trigger switches. The overall safety during the usage of high electrical currents and/or powers can therefore be improved by a usage of such circuit breakers.

Modern circuit breakers generally comprise an operating lever for a manipulation by the operator, in most cases movable at least between an OFF-position and an ON-position. Internally, the switching of the electrical current is achieved by an electrical contact system, the electrical contact system usually comprising one or more pairs of fixed and movable contacts. A latching mechanism is provided in between, mechanically connected both to the operating handle and the electrical contact system. Therefore, a manipulation of the operating lever by the operator results in a change in the electrical contact system, for instance, a change of the position of the operating lever between its OFF-position and its ON-position results in a closing of the contacts of the electrical contact system.

During the movement of the operating handle into its ON-position in addition to the closing of the contacts of the electrical contact system, also an arming of the protection system(s) in the circuit breaker is necessary. Especially after the occurrence of a tripping incident, for instance an overcurrent or a short-circuit, this arming needs a reset of the circuit breaker, especially of the latching mechanism of the circuit breaker. In such a reset especially of the latching mechanism, also the normal operation of the circuit breaker, e.g. induced by switching the operating lever from its OFF-position in its ON-position, can be prepared. Without a reset of the latching mechanism, the latching mechanism cannot be activated in a subsequent movement of the operating lever in its ON-position and the electrical contact system of the circuit breaker cannot be closed and in addition the protection systems of the circuit breaker cannot be armed.

It is known in circuit breakers according to the state of the art, to provide a separate RESET-position, in which the operating lever has to be moved to internally reset the latching mechanism. The RESET-position is known to be at least slightly different from the OFF-position, wherein the force necessary during the movement into the RESET-position is used to reset the latching mechanism. To achieve all resetting actions, this force can be quite large, which is unpleasant for the operator. In known circuit breakers this force often has its largest value when the operating lever is in its RESET-position. A high stress and/or strain acting on the operating lever can therefore occur, over and above hindering the actuation of the operating lever by an actuation unit. In addition, if the operating lever is in its OFF-position, it is not clearly visible to the operator, whether the circuit breaker can immediately be switched on or if prior to that to this a movement of the operating lever into the RESET-position is necessary. This can cause confusion for the operator.

### SUMMARY

At least one embodiment of the present invention involves solving at least one of the aforesaid problems and drawbacks, at least partly. In particular, at least one embodiment of the present invention provides a method for operating a circuit breaker and a circuit breaker, which allow a more simple and convenient operation in an easy and cost-efficient way.

At least one embodiment of the present invention is directed to a method for operating a circuit breaker. At least one embodiment of the present invention is directed to a circuit breaker. Further features and details of the present invention result from the claims, the description and the drawings. Features and details discussed with respect to the method for operating a circuit breaker can also be applied to the circuit breaker and vice versa, if of technical sense.

A first aspect of an embodiment of the invention is directed to a method for operating a circuit breaker, the circuit breaker comprising an operating lever, a latching mechanism and an electrical contact system with a movable contact and a fixed contact, wherein the operating lever is movable into an ON-position and an OFF-position, wherein further the operating lever is mechanically connected to the electrical contact system via the latching mechanism such that when the operating lever is in its OFF-position the contacts of the electrical contact system are opened and that when the operating lever is in its ON-position, the contacts of the electrical contact system are closed. The method comprises:

moving the operating lever in its OFF-position; and

preparing a subsequent activation of the latching mechanism during movement of the operating lever in its OFF-position by resetting the latching mechanism.

Further, according to a second aspect of an embodiment of the invention, a circuit breaker is disclosed comprising an operating lever, a latching mechanism and an electrical contact system with a movable contact and a fixed contact, wherein the operating lever is movable into an ON-position, an OFF-position and a RESET-Position, wherein further the operating lever is mechanically connected to the electrical contact system via the latching mechanism such that when the operating lever is in its OFF-position the contacts of the electrical contact system are opened, that when the operating lever is in its ON-position the contacts of the electrical contact system are closed and that when a movement of the operating lever in its RESET-position an activation of the latching mechanism is prepared by resetting the latching mechanism.

### BRIEF DESCRIPTION OF THE DRAWINGS

The present invention is descripted with respect to the accompanying figures. The figures show schematically:

FIG. 1 a method according to an embodiment of the invention, and

FIG. 2 a sectional view of a circuit breaker according to an embodiment of the invention.

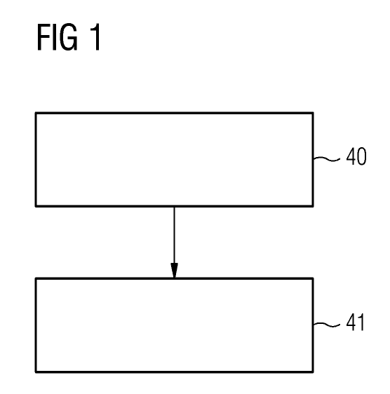

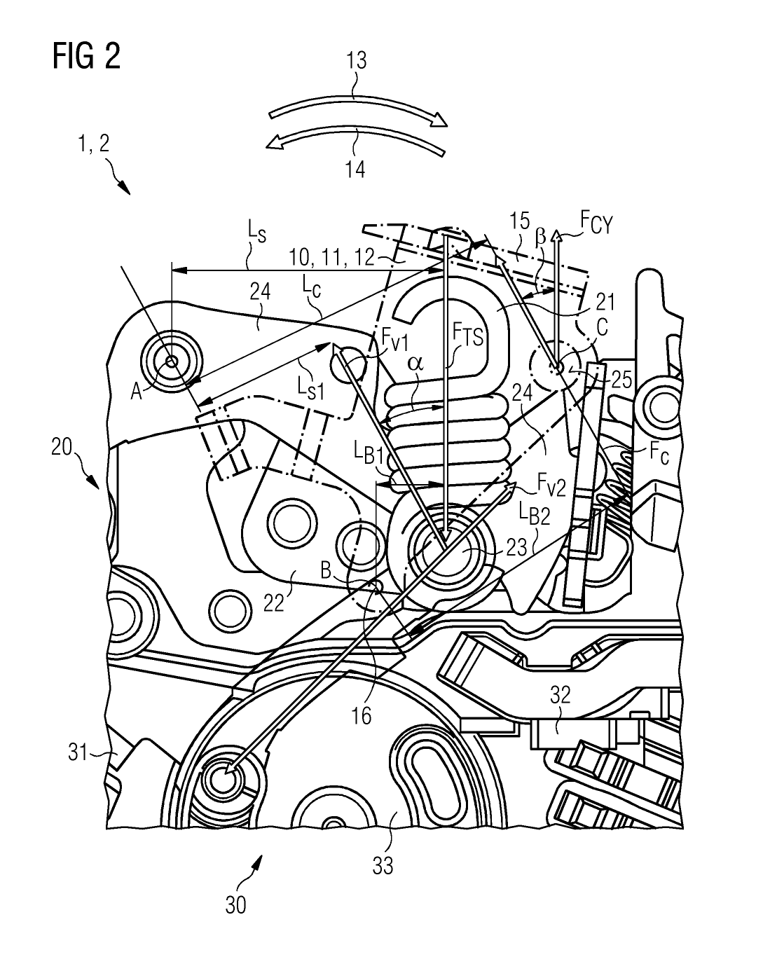

Elements having the same functions and mode of action are provided in FIGS. 1 and 2 with the same reference signs.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

A first aspect of an embodiment of the invention is directed to a method for operating a circuit breaker, the circuit breaker comprising an operating lever, a latching mechanism and an electrical contact system with a movable contact and a fixed contact, wherein the operating lever is movable into an ON-position and an OFF-position, wherein further the operating lever is mechanically connected to the electrical contact system via the latching mechanism such that when the operating lever is in its OFF-position the contacts of the electrical contact system are opened and that when the operating lever is in its ON-position, the contacts of the electrical contact system are closed. The method comprises:

moving the operating lever in its OFF-position; and

preparing a subsequent activation of the latching mechanism during movement of the operating lever in its OFF-position by resetting the latching mechanism.

The method according to an embodiment of the invention can be used to operate a circuit breaker with an operating lever. The operating lever or its handle section, respectively, can be operated by an operator, for instance be moved into an ON-position and an OFF-position. Inside the circuit breaker, an electrical contact system comprises at least a movable contact and a fixed contact for the switching of the electrical current is provided. Of course, the electrical contact system can comprise more than one pair of movable and fixed contacts.

The operating lever and the electrical contact system are both mechanically connected to a latching mechanism, the latching mechanism therefore providing a mechanical connection between the operating lever and the electrical contact system. Especially, it can be ensured by this connection that when the operating lever is in its OFF-position the contacts of the electrical contact system are opened and that when the operating lever is in its ON-position the contacts of the electrical contact system are closed.

Of course, safety devices such as for instance an overcurrent protection and/or a short-circuit protection and the respective trigger switches can additionally be provided in the circuit breaker, especially as an integral part of the latching mechanism and/or the electrical contact system. To ensure a successful operation of the circuit breaker, meaning that the electrical contact system is being closed when the operating lever is moved into its ON-position and especially that any provided safety device is armed, a reset of the latching mechanism is necessary.

This can be fulfilled in an easy way with the steps a) and b) of the method according to an embodiment of the invention. In step a), the operating lever is moved into its OFF-position. This can be achieved for instance by a direct manual operation of the operating lever or its handle section, respectively, by an operator. Before the movement into its OFF-position, the operating lever can be positioned for instance in its ON-position or even in a TRIP-position, for instance if the safety device was triggered by an incident like an overcurrent or a short-circuit.

In step b) 41 of the method according to an embodiment of the invention, a reset of the latching mechanism is simultaneously carried out. The reset is thereby carried out during the movement of the operating lever into its OFF-position. Thus, the OFF-position serves simultaneously as a RESET-position. A subsequent activation of the latching mechanism by moving the operating lever into its ON-position is possible without any further procedural steps. All energy and/or force needed to reset the latching mechanism are extracted out of this movement of the operating lever into its OFF-position.

The whole duration of the movement into the OFF-position can be used to carry out the resetting procedure, therefore, an actual force needed to carry out the reset can be reduced. This force can especially provide a maximum value during the movement and a lower value at the end of the movement, when the operating lever is in or near its OFF-position. A low or preferable evanescent stress and/or strain load acting on the operating lever in its OFF-position can be achieved. In addition, no separate reset procedure has to be performed. The convenience for the operator can therefore be enhanced. Further, no separate RESET-position for the operating handle has to be provided. This, especially in combination with the reduced force requirements, can enable a more compact and easy assembly of the circuit breaker.

Further, a method according to an embodiment of the invention can include that the operating lever in step a) is moved in a single direction. A movement in a single direction according to an embodiment of the invention is thereby a movement without a change of its general direction, for instance in case of a circular movement, either clockwise or counterclockwise. Such a movement in a single direction is a very simple movement and especially easy to carry out, for instance by an operator. A method according to an embodiment of the invention can therefore be further simplified.

In addition, in a further improvement of a method according to an embodiment of the invention, the single direction is opposite to the direction of a movement of the operating lever from its OFF-position into its ON-position. By this, it is possible to limit the movement of the operating lever between its ON-position and its OFF-position. The operating lever can therefore only be moved between these two end positions of the movement of the operating lever. An eventually available TRIP-position can be arranged in between these two positions. Every movement of the operating lever into its OFF-position therefore includes a reset of the latching mechanism. Thereby an even more compact and easy assembly of the circuit breaker can be achieved.

According to another preferred development of an embodiment of the invention, a method according to an embodiment of the invention can include that after step b) the operating lever is held in its OFF-position by the activated latching mechanism. For instance, the activated latching mechanism can provide a spring element to create a force and/or torque to hold the operating lever in its OFF-position. Therefore an exit of the operating lever out of its OFF-position on its own can be prohibited. The operating lever stays in its OFF-position until an external actuation, for instance by an operator. An unintentional operation of the circuit breaker, especially including a closing of the electrical contact system, can therefore be prohibited. By this the safety provided by a circuit breaker can be enhanced.

Further, according to a second aspect of an embodiment of the invention, a circuit breaker is disclosed comprising an operating lever, a latching mechanism and an electrical contact system with a movable contact and a fixed contact, wherein the operating lever is movable into an ON-position, an OFF-position and a RESET-Position, wherein further the operating lever is mechanically connected to the electrical contact system via the latching mechanism such that when the operating lever is in its OFF-position the contacts of the electrical contact system are opened, that when the operating lever is in its ON-position the contacts of the electrical contact system are closed and that when a movement of the operating lever in its RESET-position an activation of the latching mechanism is prepared by resetting the latching mechanism.

A circuit breaker according to an embodiment of the invention comprises an operating lever. The operating lever or its handle section respectively can be operated by an operator, for instance be moved into the ON-position, the RESET-position and the OFF-position. Inside the circuit breaker, a electrical contact system comprising at least a movable contact and a fixed contact for the switching of the electrical current is provided. Of course the electrical contact system can comprise more than one pair of movable and fixed contacts. The operating lever and the electrical contact system are both mechanically connected to a latching mechanism, the latching mechanism therefore providing a mechanical connection between the operating lever and the electrical contact system.

In particular, it can be ensured by this connection that when the operating lever is in its OFF-position the contacts of the electrical contact system are opened and that when the operating lever is in its ON-position the contacts of the electrical contact system are closed. Of course, safety devices such as for instance an overload protection and/or a short-circuit protection and the respective trigger switches can additionally be provided in the circuit breaker, especially as an integral part of the latching mechanism and/or the electrical contact system. To ensure a successful operation of the circuit breaker, meaning that the electrical contact system is being closed when the operating lever is moved into its ON-position and especially that any provided safety device is armed, a reset of the latching mechanism is necessary. This can be achieved by moving the operating lever into its RESET-position. An activation of the latching mechanism and/or an arming of any safety devices triggered by a subsequent movement of the operating lever in its ON-position can thereby be secured.

A circuit breaker according to an embodiment of the invention includes the OFF-position of the operating lever and the RESET-position of the operating lever being identical. Therefore, the resetting of the latching mechanism and, if applicable, the preparation of an arming of the safety devices triggered during a subsequent movement of the operating lever in its ON-position, can already be carried out simply by moving the operating lever into its OFF-position. An additional movement of the operating lever into a position different from the OFF-position in order to reset the internal mechanism of the circuit breaker can therefore be avoided. The convenience for the operator can therefore be enhanced. Further, no separate RESET-position for the operating handle must be provided. This can enable a more compact and easy assembly of the circuit breaker.

Further, a circuit breaker according to an embodiment of the invention includes that the circuit breaker is enabled to carry out a method according to the first aspect of an embodiment of the invention. By carrying out such a method, a circuit breaker provides the same advantages which have been discussed in detail with respect to a method for operating a circuit breaker according to the first aspect of an embodiment of the invention.

In addition, a circuit breaker according to an embodiment of the invention includes a latching mechanism that comprises at least one spring element, the spring element holding the operating lever in its OFF-position after the movement of the operating lever into its OFF-position. Spring elements are an easy mechanical device which can provide a force and/or a torque. With such a force and/or torque it is especially easy to hold the operating lever in its OFF-position. The operating lever stays in its OFF-position until an external actuation, for instance by an operator. An unintentional operation of the circuit breaker, especially including a closing of the electrical contact system, can therefore be prohibited. By this, the safety provided by a circuit breaker can be enhanced.

Additionally, a circuit breaker according to an embodiment of the invention includes an actuation unit that drives the operating lever and/or the latching mechanism. An automatic and/or remote operation of the circuit breaker can thereby be provided. In particular, an application of a circuit breaker according to the invention in a hazardous environment and/or environments without a direct accessibility can be provided.

In FIG. 1 a method according to an embodiment of the invention is shown. FIG. 2 shows a possible embodiment of a circuit breaker 1 according to the invention. In the following, the two figures are described together with reference to the particular figure if applicable.

A circuit breaker 1 according to an embodiment of the invention comprises an operating lever 10. A handle 15 of the operating lever 10 can be accessed by an operator and be manually operated. In the interior of the circuit breaker 1, the operating lever 10 is mechanically connected to a latching mechanism 20. The latching mechanism 20 is further mechanically connected to an electrical contact system 30. In the embodiment shown, the electrical contact system 30 comprises several pairs of contacts 31, 32 of which one movable 31 and one fixed contact 32 are shown. The contact 31 is mounted at a rotor 33. The mechanical connections between the operating lever 10 and the latching mechanism 20 and the latching mechanism 20 and the electrical contact system 30, respectively, are established such that when the operating lever 10 is in its OFF-position 11 the contacts 31, 32 of the electrical contact system 30 are opened and that when the operating lever 10 is in its ON-position the contacts 31, 32 of the electrical contact system 30 are closed by a correspondent rotation of the rotor 33 of the electrical contact system 30. For this purpose, the latching mechanism 20 comprises several mechanical elements of which an upper toggle lever 22, a tension lever 24 and a spring element 21 are exemplarily shown.

In step a) 40 of a method according to an embodiment of the invention, the operating lever 10 is moved into its OFF-position 11 as it is shown in FIG. 2. This can for instance either be manually carried out by an operator or by an actuation unit 2 (not shown) mechanically connected to the operating lever 10. According to an embodiment of the invention, it is provided in step b) 41 that already during this movement the latching mechanism 20 is resetted. A subsequent activation of the latching mechanism 20 is therefore immediately possible. Such an activation can solely comprise a closure of the electrical contact system 30 but also comprise the preparation of an arming of any provided safety device as for instance an overcurrent protection and/or a short-circuit protection and the respective trigger switches. A separate RESET-position 12 of the operating handle 10 is therefore not needed, the OFF-position 11 and the RESET-position 12 of the operating handle 10 of a circuit breaker 1 according to an embodiment of the invention are identical.

Especially in the embodiment of a circuit breaker 10 shown in FIG. 2, the operating handle 10 is moved in a single direction 13 into its OFF-11 and RESET-position 12, the single direction 13 in particular opposite to a direction 14 of a movement of the operating lever 10 from its OFF-position 11 into its ON-position (not shown). Further, the already mentioned mechanical elements of the latching mechanism 20 are both mechanically connected to the operating lever 10, the upper toggle lever 22 at a toggle lever shaft 23 and the tension lever 24 at a tension bolt 25. The operating lever 10 itself is pivot-mounted in the circuit breaker 1 at a handle join 16. At the toggle lever shaft 23 and the tension bolt 25, the upper toggle lever 22 and the tension lever 24 respectively are exerting forces onto the operating lever 10. The latching mechanism 20 is according to the invention constructed such, that the resulting torque drives the operating lever 10 into its OFF-position 11, e.g. clockwise in the shown embodiment of the circuit breaker 1 according to the invention. No active force is therefore needed to hold the operating lever 10 in its OFF-position 11, for instance the implementation of an activation unit 2 (not shown) can thereby be made easier.

The aforementioned description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure and appended claims.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Still further, any one of the above-described and other example features of the present invention may be embodied in the form of an apparatus, method, system, etc. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### REFERENCE SIGNS

1 Circuit breaker
2 Actuation unit
10 Operating lever
11 OFF-position
12 RESET-position
13 Direction
14 Direction
15 Handle
16 Handle join
20 Latching mechanism
21 Spring element
22 Toggle lever
23 Toggle lever shaft
24 Tension lever
25 Tension bolt
30 Electrical contact system
31 Movable contact
32 Fixed contact
33 Rotor
40 Step a)
41 Step b)

What is claimed is:

1. A method for operating a circuit breaker, the circuit breaker including an operating lever, a latching mechanism and an electrical contact system with a movable contact and a fixed contact, the operating lever being movable into an ON-position and an OFF-position and being mechanically connected via the latching mechanism to the electrical contact system such that when the operating lever is in the OFF-position, the movable and fixed contacts of the electrical contact system are opened and when the operating lever is in the ON-position, the movable and fixed contacts of the electrical contact system are closed, the method comprising:
moving the operating lever in the OFF-position; and
preparing a subsequent activation of the latching mechanism during movement of the operating lever in the OFF-position by resetting the latching mechanism.

2. The method of claim 1, wherein the operating lever is moved in a single direction.

3. The method of claim 2, wherein the single direction is opposite to a direction of a movement of the operating lever from the OFF-position into the ON-position.

4. The method of claim 1, further comprising:
holding, after the preparing, the operating lever in the OFF-position via the activated latching mechanism.

5. A circuit breaker, comprising:
an operating lever;
a latching mechanism; and
an electrical contact system including a movable contact and a fixed contact, the operating lever being movable into an ON-position, an OFF-position and a RESET-Position and being mechanically connected via the latching mechanism to the electrical contact system such that when the operating lever is in the OFF-position, the movable and fixed contacts of the electrical contact system are opened, and when the operating lever is in the ON-position, the movable and fixed contacts of the electrical contact system are closed, wherein when moving the operating lever in the RESET-position, an activation of the latching mechanism is prepared by resetting the latching mechanism, and wherein the OFF-position of the operating lever and the RESET-position of the operating lever are identical.

6. The circuit breaker of claim 5, wherein after moving the operating lever in the OFF-position, a subsequent activation of the latching mechanism is prepared, during movement of the operating lever in the OFF-position, by resetting the latching mechanism.

7. The circuit breaker of claim 5, wherein the latching mechanism comprises at least one spring element, the spring element being configured to hold the operating lever in the OFF-position after the movement of the operating lever into the-OFF-position.

8. The circuit breaker of claim 5, wherein the circuit breaker drives at least one of the operating lever and the latching mechanism.

9. The method of claim 2, further comprising:
holding, after the preparing, the operating lever in the OFF-position via the activated latching mechanism.

10. The method of claim 3, further comprising:
holding, after the preparing, the operating lever in the OFF-position via the activated latching mechanism.

11. The circuit breaker of claim 6, wherein the latching mechanism comprises at least one spring element, the spring element being configured to hold the operating lever in the OFF-position after the movement of the operating lever into the OFF-position.

12. The circuit breaker of claim 5, wherein another circuit breaker drives at least one of the operating lever and the latching mechanism.

13. The circuit breaker of claim 6, wherein the circuit breaker drives at least one of the operating lever and the latching mechanism.

14. The circuit breaker of claim 7, wherein the circuit breaker drives at least one of the operating lever and the latching mechanism.

15. The circuit breaker of claim 6, wherein another circuit breaker drives at least one of the operating lever and the latching mechanism.

16. The circuit breaker of claim 7, wherein another circuit breaker drives at least one of the operating lever and the latching mechanism.
